(19) United States
(12) Patent Application Publication
(10) Pub. No.: US 2026/0146158 A1
(43) Pub. Date: May 28, 2026

(54) FOAMABLE RESIN COMPOSITION

(71) Applicant: TPK Material Solutions (Xiamen) Inc., Xiamen(area A) (CN)

(72) Inventors: Ya Wan Chen, Hsinchu County (TW); Yu Li, Hebei Province (CN); Yu-Chia Lin, Taipei City (TW); Chin Hui Lee, Taipei City (TW)

(21) Appl. No.: 19/454,262

(22) Filed: Jan. 20, 2026

Related U.S. Application Data
(63) Continuation of application No. 19/098,094, filed on Apr. 2, 2025.

(30) Foreign Application Priority Data
Apr. 11, 2024 (CN) 202410436835.5

(51) Int. Cl. C08L 75/16; C08F 2/50; C08F 283/00; C08J 9/228; C08K 5/17

(52) U.S. Cl. CPC C08L 75/16; C08F 2/50; C08F 283/008; C08J 9/228; C08K 5/17; C08J 2201/034; C08J 2203/22; C08J 2375/16; C08L 2205/20

(57) ABSTRACT

The present disclosure provides a foamable resin composition. The foamable resin composition includes a polyurethane (meth) acrylate oligomer, a photoinitiator, a heat-expandable microcapsule, and a photopolymerizable monomer.

### CROSS-REFERENCE TO RELATED APPLICATIONS

This application is a continuation of U.S. patent application Ser. No. 19/098,094, filed on Apr. 2, 2025, which claims priority to China Patent Application 202410436835.5, filed on Apr. 11, 2024. U.S. patent application Ser. No. 19/098,094 and China Patent Application 202410436835.5 are incorporated herein by reference.

### FIELD OF DISCLOSURE

The present disclosure relates to a resin composition used in the continuous liquid interface production (CLIP) of three-dimensional (3D) printing technology, especially a foamable resin composition used in the continuous liquid interface production.

### DESCRIPTION OF RELATED ART

The continuous liquid interface production (CLIP) of 3D printing technology uses ultraviolet (UV) light to project onto a resin tank with a transparent bottom, making the liquid photosensitizing resin therewithin form a shape through light curing. Detailed steps are disclosed in Tumbleston et al. (2015), Science, 347(6228), 1349-1352. Indeed, a short UV wavelength used in the continuous liquid interface production of 3D printing technology achieves fine resolution in the printed object. However, because the manufacturing production is carried out layer by layer, there is still a need to improve production efficiency.

Carbon3D, Inc. discloses in U.S. patent Ser. No. 11/292,186B2 an additive manufacturing technique that includes adding a foamable resin composition having microcapsules mixed in a matrix resin composition, wherein the foamable resin composition is placed in a CLIP machine to be printed and exposed to UV light to form an intermediate object. Later, the intermediate object is thermally cured to form a final product, while the microcapsules mixed in the matrix resin composition expand simultaneously during the heating process. By printing a smaller intermediate object and then expanding it into a larger final product, this method can lead to improved production efficiency.

Although these publications disclose the use of microcapsules in dual cure resin to compose the formable resin composition and increase the production speed, they do not report on the increased viscosity of the foamable resin composition caused by the shear thickening effect. This increased viscosity leads to layer misalignment during printing, which negatively impacts the printing quality. Additionally, a diluent can be added to counteract the viscosity increase caused by the addition of microcapsules benefits the printing of the foamable resin compositions, which also ensures the intermediate objects possesses the properties necessary for successfully expansion during the heating/expansion process. However, these issues have not been further researched in the publications.

Owing to the aforementioned reasons, there is a need to develop a foamable resin composition suitable for continuous liquid interface production and having both excellent production efficiency and printing quality. At the same time, the intermediate objects produced from the foamable resin composition through UV polymerization have heat-expandable features. Therefore, after the intermediate objects are heated, the microcapsules mixed therewithin can be fully expanded to achieve an enlarged final volume and fully heat-cured to form a final product.

### SUMMARY OF THE DISCLOSURE

The present disclosure provides a foamable resin composition comprising: urethane (meth) acrylate oligomers having an inclusion quantity of 20-90 parts by weight, photoinitiators having an inclusion quantity of 0.1-10 parts by weight, heat-expandable microcapsules having an inclusion quantity of 1-25 parts by weight, and photopolymerizable monomers having an inclusion quantity of 10-45 parts by weight, wherein the photopolymerizable monomer comprises at least one compound with chemical formula R—Xa, having a group of a reactive functional group X and a non-reactive functional group R, wherein the non-reactive functional group R is selected from a group consisting of small molecule groups, high structural steric hindrance groups, multiple reactive site groups, and long chain groups. In some embodiments, X is an alkenyl group. In some embodiments, a is 1-6. In some embodiments, the chemical formula has 0.1-˜20 parts by weight of photopolymerizable monomers with a>1, preferably in the range of 0.5-15 parts by weight, more preferably 1-10 parts by weight. In some embodiments, the chemical formula has 0-10 parts by weight of photopolymerizable monomers with a>2, preferably in the range of 0.1-5 parts by weight, more preferably 1-2 parts by weight. In some embodiments, the foamable resin composition comprises at least one compound with the chemical formula R—Xa, wherein a is 1, 2, and 3. In some embodiments, the foamable resin composition comprises at least one compound with R—Xa, wherein the amount of the compound with a>1 is 0.1-20 parts by weight and wherein the amount of compound with a=1 is 0.1-25 parts by weight.

In some embodiments, the heat-expandable microcapsule comprises an outer shell made of nitrile-based polymers enclosing an alkane-based compound.

In some embodiments, the foamable resin composition further comprises a curing agent of 0-70 parts by weight.

In some embodiments, the weight ratio of urethane (meth) acrylate oligomer and the photopolymerizable monomer in the foamable resin composition is from 1.5:1 to 2.5:1, for example, 1.5:1, 2:1, or 2.5:1.

In some embodiments, the photopolymerizable monomer comprises a compound with a chemical formula (1), a compound with a chemical formula (2), a compound with a chemical formula (3), a compound with a chemical formula (4), a compound with a chemical formula (5), a compound with a chemical formula (6), or a combination thereof:

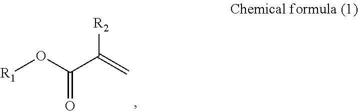

wherein R₁ is a straight-chain or branched-chain alkyl of C1-C18, a substituted cycloalkyl or non-substituted cycloalkyl, or a substituted aryl or non-substituted aryl, and R₂ is hydrogen or methyl;

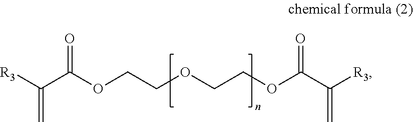

wherein R₃ is hydrogen or methyl and n is any integer from 3 to 12;

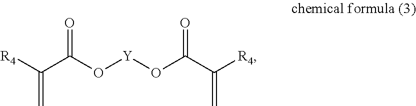

wherein Y is a straight-chain or branched-chain alkylene of C1-C18, or a substituted or non-substituted cycloalkylene; and R₄ is hydrogen or methyl;

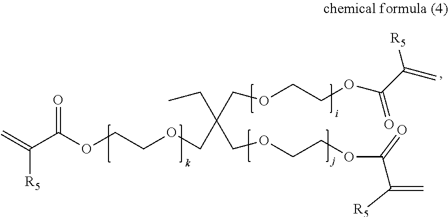

wherein i+j+k=15, and R₅ is hydrogen or methyl;

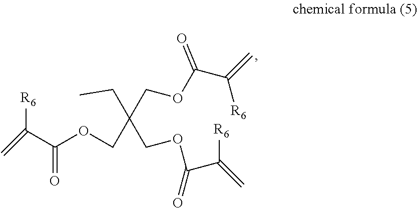

wherein R₆ is hydrogen or methyl; and

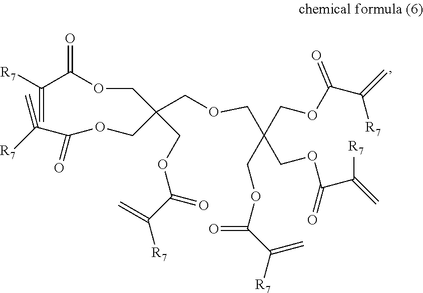

wherein R₇ is hydrogen or methyl.

In some embodiments, R₁ is methyl, ethyl, tert-butyl, dodecyl, octadecyl, isodecyl, isooctyl, isononyl, cyclohexyl, isobornyl, 2-methyl-2-adamantyl, phenyl, benzyl, phenoxy, or phenol.

In some embodiments, a compound with chemical formula (2) comprises polyethylene glycol (200) diacrylate, polyethylene glycol (400) diacrylate, polyethylene glycol (600) diacrylate, polyethylene glycol (200) dimethacrylate, polyethylene glycol (400) dimethacrylate, polyethylene glycol (600) dimethacrylate, or a combination thereof, and a compound with chemical formula (3) comprises tricyclodecane dimethanol diacrylate, 1,4-butanediol dimethacrylate or a combination thereof.

In some embodiments, a viscosity of the foamable resin composition is from 100 cps to 10,000 cps at 25° C.

In some embodiments, the inclusion quantity of the photopolymerizable monomers with chemical formula R—Xa and a≥2 in the foamable resin composition is 0.1˜20 parts by weight.

In some embodiments, the photopolymerizable monomers with a viscosity greater than 50 cps in the foamable resin composition are less than 45 parts by weight, or the photopolymerizable monomers with a viscosity greater than 100 cps in the foamable resin composition are less than 20 parts by weight.

In some embodiments, the weight ratio of a compound with a chemical formula (1) and a compound with a chemical formula (2) or a compound with chemical formula (3) is 1:1 to 12:1.

In some embodiments, the amount of the heat-expandable microcapsule in the foamable resin composition is from 2 parts by weight to 15 parts by weight.

In some embodiments, the amount of the heat-expandable microcapsule in the foamable resin composition is from 3 parts by weight to 10 parts by weight.

In some embodiments, the particle size of the heat-expandable microcapsule is from 5 μm to 100 μm.

In some embodiments, the urethane (meth) acrylate oligomer, photopolymerizable monomer, and photoinitiator can be those known and disclosed in U.S. Pat. Nos. 11,241,822, 9,598,606, 9,676,963, or U.S. Pat. No. 9,453,142.

In some embodiments, the molecular weight of the urethane (meth) acrylate oligomer is from 30,000 Da to 40,000 Da.

In some embodiments, the curing agent comprises 3,3′-dimethyl-4,4′-diaminodicyclohexylmethane (DMDC).

In some embodiments, the foamable resin composition described in any aforementioned embodiments further comprises a filler for adding desired features to the final product, for example, strengthening mechanical performance, changing surface properties, increasing/reducing weight, prolonging durability/weather resistance of final products, enhancing anti-staining effects, adding appearance effects. More specifically, desired features can be achieved by adding a filler that strengthens the final products, for example, glass fiber and other hard ingredients; adding a filler that makes the final products anti-slip, for example, mortar and rough-textured particles; adding a filler that changes the weight of the final product, for example, adding metal powder to increase the weight or adding hollow/light weighted pallets to reduce the weight; adding a filler that makes the final products durable/weather resistant, for example, adding anti-UV agents to prevent the final products from breaking down due to photodegradation; adding anti-staining agents for the final products to achieve the anti-mud effect, for example, adding antifouling powder in the foamable resin composition to be directly formed by 3D-printing, wherein the antifouling powder can be silicone-based antifouling powder or fluorine-based antifouling powder; adding various fillers that can offer the final products desired appearance and effects, for example, various coloring materials.

In some embodiments, the coloring materials can be resin pigments (masterbatch), thermochromic materials, or photochromic materials (solar discoloration ink).

The present disclosure provides a foamable resin composition suitable for continuous liquid interface production, having heat-expandable microcapsules added in the mixture of elastic dual cure resins. The elastic dual cure resin can be a composition of both the UV polymerization and thermal curing two-step reaction resin. The heat-expandable microcapsule can be a foaming particle with hollow sphere structure having an outer shell made of nitrile-based polymers and encapsulating a content of alkane-based compounds, wherein the glass transition temperature (Tg) of the shell of the heat-expandable microcapsule is smaller than the melting point temperature (Tm) of the elastic dual cure resin and smaller than the decomposition temperature (Td) thereof, which enables the outer shell of the heat-expandable microcapsule to soften during the heating process while the elastic dual cure resin neither melts nor decomposes.

In some embodiments, the outer shell of the heat-expandable microcapsule may have various colors to provide visual effects of the final products. In some embodiments, the heat-expandable microcapsule can be manufactured in black, white, red, blue, yellow, or any other desired colors.

In addition, under UV light, the photoinitiator absorbs photon energy and produces free radicals that trigger polymerization between photopolymerizable monomers and urethane (meth) acrylate oligomers.

The photopolymerizable monomer comprises compounds that have the following chemical formulas: R—Xa, wherein X is a reactive part, and R is a non-reactive part of chain-growth polymerization. More specifically, X contains a carbon-carbon double-bond (—C═C—) group that interacts with the photoinitiator, and R is the residue part that does not react with the photoinitiator. When the photoinitiator excites by UV light and produces free radicals, these free radicals would attack the carbon-carbon double-bond group in the photopolymerizable monomers, causing the double bonds of the carbon-carbon double-bond group to convert into single bonds and pi (π) electrons and, as a result, the photopolymerizable monomer becomes a carbocation intermediate; the carbocation intermediates and the urethane (meth) acrylate oligomers undergo crosslinking and form polymer webs. In other words, the X part of the photopolymerizable monomer and the urethane (meth) acrylate oligomer undergo reactions, whereas the R part of the photopolymerizable monomer is the non-reactive part of chain-growth polymerization. Detailed descriptions are disclosed in the publication of Konuray et al. (2018), Polymers, 10(2), 178.

In some embodiments, the X part of the photopolymerizable monomer is reactive part, while R is a non-reactive part of chain-growth polymerization. More specifically, X is a carbon-carbon double-bond (—C═C—) group used to interact with the photoinitiator, and R is the residue group that does not react with the photoinitiator.

In some embodiments, the R part of the photopolymerizable monomer with the chemical formula R—Xa is a residue part having steric hindrance. In detail, R is a bulky occupancy near a reactive site. The photopolymerizable monomer having an R group with steric hindrance can create a space while binding with the pendant of the polymer backbone. Such a space can create a reactive space for the remaining types of photopolymerizable monomers; more specifically, such a space can be used as a spacer during the binding process of the photopolymerizable monomer and the urethane (meth) acrylate oligomer to reduce entanglement between photopolymerizable monomers and facilitate reactions smoothly. In addition to the impact on the chain-growth polymerization, the residue with steric hindrance also contributes to the overall performance of the intermediate object after UV polymerization; more specifically, when the R group of the photopolymerizable monomers having steric hindrance is bound with the backbone of oligomers and the R group of the photopolymerizable monomers limits the chain mobility thereof, making bonds difficult to rotate or slip. Therefore, after the UV polymerization, the intermediate object tends towards being more rigid and has stronger mechanical strength.

In some embodiments, the photopolymerizable monomer with chemical formula R—Xa has an R part comprising long-chain groups, for example, long-chain alkyl, alkyl of C3-C30, preferably alkyl of C3-C20, more preferably alkyl of C3-C12. Photopolymerizable monomers having long-chain alkyl can provide higher rotational freedom to the polymer backbone, making the intermediate object softer and have a better deformation capability after UV polymerization.

In some embodiments, the photopolymerizable monomer with the chemical formula R—Xa has an R part comprising long chains at the side reaction site. These side reaction sites can increase interactions between molecules, making adjacent polymer chains form a linkage. In some embodiments, the R part is a polyether long chain, wherein the side reactive site is where the oxygen (O) is located, and possibly forms a hydrogen bond with molecules of adjacent polymer chains. In addition to the main reaction occurring at the X part, side reactions also occur at the R part so that the degree of crosslinking is enhanced, making interconnected networks much more refined and strengthening the flexibility of the intermediate object after UV polymerization.

In some embodiments, the photopolymerizable monomer with chemical formula R—Xa has an R part that is a small molecule group, having a small spatial location and a low molecular weight. In other words, small molecule photopolymerizable monomers can provide more reaction sites per unit weight than larger molecule photopolymerizable monomers. Such a method can increase the crosslinking density. In some embodiments, the photopolymerizable monomer is methyl methacrylate (MMA), ethyl methacrylate, or a combination thereof.

In some embodiments, the viscosity of the photopolymerizable monomer is from 1 cps to 7,000 cps at 25° C.

In some embodiments, the foamable resin composition comprises one or many aforementioned photopolymerizable monomers with the chemical formula R—Xa.

### DETAILED DESCRIPTION OF THE PREFERRED EMBODIMENTS

To better describe and explain more completely the present disclosure, various forms and comprehensive descriptions of embodiments are provided as follows. Embodiments of the present disclosure are not limited to one form, and the embodiments may be combined or replaced under beneficial circumstances. Without further explanations, other embodiments may be included in the contents of the present disclosure.

The present disclosure provides a foamable resin composition. The foamable resin composition comprises a polyurethane (meth) acrylate oligomer (that is, polyurethane acrylate oligomer or urethane meth acrylate oligomer), a photoinitiator, a heat-expandable microcapsule, and a photopolymerizable monomer. The foamable resin composition further comprises a curing agent. The present disclosure provides a foamable resin composition comprising 20-90 parts by weight of urethane (meth) acrylate oligomer, 0.1-10 parts by weight of photoinitiators, 1-25 parts by weight of heat-expandable microcapsules, 0-70 parts by weight of hardener, and 10-45 parts by weight of photopolymerizable monomers. The photopolymerizable monomer comprises a compound with the following chemical formulas: R—Xa, wherein X is a reactive part, and R is a non-reactive part of chain-growth polymerization. In some embodiments, the photopolymerizable monomer includes X, a reactive part, and R, a non-reactive part of the chain-growth polymerization, wherein the reactive monomer R—Xa includes a number of any integer from 1 to 6 of the reactive functional group X, a non-reactive-part-of-chain-growth polymerization group R, and a plurality of reaction sites in the group R that can form a hydrogen bond, wherein R is a combination selected from the following elements: small molecule group, group with steric hindrance, group at the side reaction site, and long-chain group.

First, urethane (meth) acrylate oligomer is introduced. Since elements of urethane (meth) acrylate oligomer can interact with each other through crosslinking reaction, ending in solidification, urethane (meth) acrylate oligomers are used as the structural support during the formation of resin products. In some embodiments, urethane (meth) acrylate oligomers can be obtained from commercial suppliers or manufactured through known methods. For example, methods are known and reported in the publication of Velankar, Pazos, and Cooper, Journal of Applied Polymer Science 162, 1361 (1996), or disclosed in the patents granted to Carbon3D, Inc., including methods reported in U.S. Pat. Nos. 10,471,655, 10,350,823, or U.S. Pat. No. 9,453,142, wherein relevant contents thereof have been cited in the present disclosure. In some embodiments, preferable urethane (meth) acrylate oligomers include compounds having a chemical formula (7):

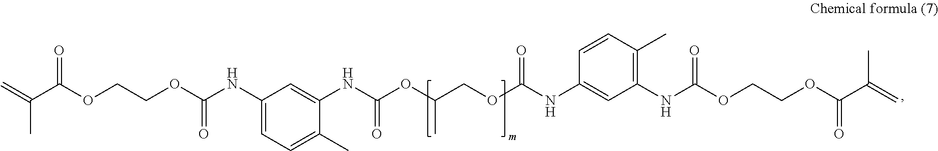

wherein m is any integer from 500 to 700. In some embodiments, the molecular weight of the preferable urethane (meth) acrylate oligomer is from 30000 Da to 40000 Da, for example, 30000 Da, 32500 Da, 35000 Da, 37500 Da, or 40000 Da so that the foamable resin composition would not have an excess viscosity and would still have a backbone structure long enough to provide sufficient structural support. In some embodiments, the preferable urethane (meth) acrylate oligomer having an inclusion quantity in the foamable resin composition is from 20 parts by weight to 90 parts by weight, for example, 20 parts by weight, 30 parts by weight, 40 parts by weight, 50 parts by weight, 60 parts by weight, 70 parts by weight, 80 parts by weight, or 90 parts by weight.

Next, the photopolymerizable monomer is introduced. The photopolymerizable monomer in the present disclosure, as described in the aforementioned paragraphs, can reduce the viscosity of the foamable resin composition and improve the printing quality. In some embodiments, the viscosity of the foamable resin composition is from 100 cps (also known as cP, centipoise) to 10000 cps at 25° C., preferably 1000 cps-8000 cps, more preferably 1500 cps-6000 cps. In some embodiments, the viscosity of the foamable resin composition is preferably from 1,500 cps to 5,000 cps at 40° C.

The photopolymerizable monomer can reduce the viscosity of the foamable resin composition to prevent difficulty in 3D printing when the viscosity of the foamable resin composition is too high. Therefore, the photopolymerizable monomer can improve the quality of 3D printing. Suitable photopolymerizable monomers can be obtained from various commercial suppliers or manufactured through known methods. For example, photopolymerizable monomers can be selected from products of Sartomer Company, including SR313A, SR399, SR340, SR423SN, CD406, CD590, SR506SN, SR252, SR259, SR295, SR508, SR540, SR214, SR9035, SR421, SR238, SR602; or from products of Eternal Materials Co., Ltd., including EM70, EM75, EM90, EM210, EM221, EM225, EM2380, EM2192, EM218, EM226, EM227, EM242, EM265, EM309, EM315, EM320, EM3205, EM2306, EM327, EM328, EM331; or from products of Fairmont Material Technology Co., Ltd., including LM-D300M, LM-20TA, LM-A022. The viscosity of the photopolymerizable monomer is from 1-7000 cps at 25° C. Preferably the photopolymerizable monomer has a viscosity greater than 50 cps, which accounts for less than 45 parts by weight in the overall composition and a viscosity greater than 100 cps, which accounts for less than 20 parts by weight in the overall composition. More preferably, the photopolymerizable monomer has a viscosity greater than 50 cps, which accounts for less than 20 parts by weight in the overall composition and a viscosity greater than 100 cps, which accounts for less than 10 parts by weight in the overall composition.

More information on photopolymerizable monomers is provided as follows. The photopolymerizable monomer of the present disclosure can produce intermediate objects with suitable properties after UV polymerization by adjusting the degree of polymerization, reaction speed, and form of crosslinking reactions of UV polymerization, or by selecting different types and proportions of monomers. Thus, the resulting intermediate objects provide sufficient wrapping strength to the microcapsules during the following thermal curing process to prevent microcapsules from exploding, yet provide sufficient ductility to the microcapsules to enable the microcapsules to fully expand during the process. Therefore, the resulting intermediate object allows the microcapsules to fully expand while keeping the shell of the microcapsules intact, which increases the volume expansion ratio of the heat-expandable microcapsule. As a result, this enhances the production efficiency and capacity of 3D printing.

In some embodiments, the foamable resin composition comprises at least one or more photopolymerizable monomers with chemical formula R—Xa, wherein X is a reactive part and R is a non-reactive part of chain-growth polymerization; wherein the reactive monomer R—Xa includes a number of any integer from 1 to 6 of the reactive functional group X, a non-reactive part of chain-growth polymerization group R, and a plurality of reaction sites in the group R that can form a hydrogen bond, wherein R is a combination selected from the following elements: small molecule group, group with steric hindrance, group at the side reaction site, and long-chain group; wherein photopolymerizable monomers with the small molecule group, group with steric hindrance, and long-chain group (for example, long-chain alkyl) comprise a compound having a chemical formula (1), chemical formula (4), chemical formula (5), or chemical formula (6); wherein photopolymerizable monomers with the group at the side reaction site comprise a compound having a chemical formula (2) or chemical formula (3). Further descriptions are provided as follows:

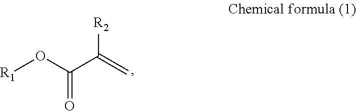

wherein R₁ is a straight-chain or branched-chain alkyl (for example, a straight-chain or branched-chain alkyl of C1-C18, such as methyl, ethyl, tert-butyl, dodecyl, octadecyl, isodecyl, isooctyl, isononyl), a substituted cycloalkyl or non-substituted cycloalkyl (such as cycloalkyl of C3-C11 (for example, cyclohexyl), isobornyl, 2-methyl-2-adamantyl), or substituted aryl or non-substituted aryl (such as phenyl, benzyl, phenoxy, or phenol); and R₂ is hydrogen or methyl (for example, methyl). When the photopolymerizable monomer includes the small molecule group, R₁ can be methyl or ethyl. When the photopolymerizable monomer includes the group with steric hindrance, R₁ can be tert-butyl, isobornyl, 2-methyl-2-adamantyl, cyclohexyl, phenyl, benzyl, phenoxy, or phenol. When the photopolymerizable monomer includes the long-chain group, R₁ can be dodecyl, octadecyl, isodecyl, isooctyl, and isononyl.

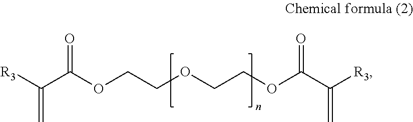

wherein R₃ is hydrogen or methyl, and n is any integer from 3 to 12, for example, 3, 4, 5, 6, 7, 8, 9, 10, 11, or 12.

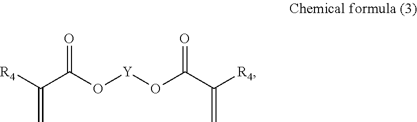

wherein Y is a straight-chain or branched-chain alkylene (for example, straight-chain or branched-chain alkylene of C1-C18) or a substituted or non-substituted cycloalkylene; and R₄ is hydrogen or methyl;

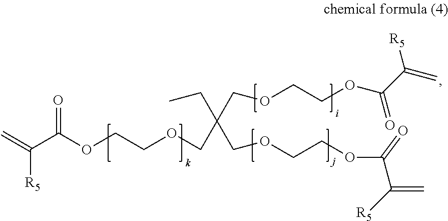

wherein i+j+k=15, and R₅ is hydrogen or methyl;

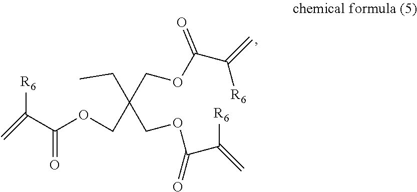

wherein R₆ is hydrogen or methyl; and

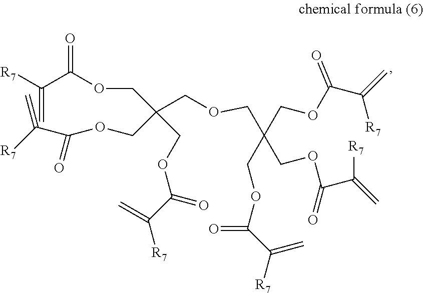

wherein R₇ is hydrogen or methyl.

In some embodiments, the photopolymerizable monomer comprises a compound with chemical formula (1), a compound with chemical formula (2), a compound with chemical formula (3), a compound with chemical formula (4), a compound with chemical formula (5), a compound with chemical formula (6), or a combination thereof. In some embodiments, the photopolymerizable monomer comprises a compound with chemical formula (1); at least one of a compound with chemical formula (2) and a compound with chemical formula (3); and at least one of a compound with chemical formula (4) and a compound with chemical formula (5), wherein the compound with chemical formula (1) contained in the foamable resin composition accounts for 0.1-25 parts by weight of the foamable resin composition. The compound of at least one of a compound with the chemical formula (2) and a compound with the chemical formula (3), and the compound of at least one of a compound with the chemical formula (4) and a compound with the chemical formula (5) contained in the foamable resin composition together account for 0.1-20 parts by weight of the foamable resin composition.

In some embodiments, the photopolymerizable monomer, having the R part of the small molecule group, comprises methyl methacrylate (MMA), ethyl methacrylate, or a combination thereof.

In some embodiments, the photopolymerizable monomer, having the R part with steric hindrance, comprises tert-butyl acrylate, isobornyl acrylate (IBOA), 2-Methyl-2-adamantyl acrylate, cyclohexyl methacrylate, benzyl methacrylate, ethoxylated trimethylolpropane triacrylate, trimethylolpropane trimethacrylate, dipentaerythritol hexaacrylatelol, or the combination thereof.

In some embodiments, the photopolymerizable monomer, having the R part with the long-chain group, comprises lauryl methacrylate (LMA), stearyl acrylate (SA), isodecyl acrylate (ISODA), isooctyl acrylate (IOA), isononyl acrylate (INAA), or the combination thereof.

In some embodiments, the photopolymerizable monomers, having the R part with the long-chain at the side reaction site, comprises polyethylene glycol (200) diacrylate (PEG(200)DA), polyethylene glycol (400) diacrylate (PEG(400)DA), polyethylene glycol (600) diacrylate (PEG(600)DA), polyethylene glycol (200) dimethacrylate (PEG(200)DMA), polyethylene glycol (400) dimethacrylate (PEG(400)DMA), polyethylene glycol (600) dimethacrylate (PEG(600)DMA), or the combination thereof.

In some embodiments, the photopolymerizable monomers, having the side reaction site, comprise tricyclodecane dimethanol diacrylate, 1,4-Butanediol dimethacrylate (BDMA), or the combination thereof.

In some embodiments, the photopolymerizable monomer contained in the foamable resin composition is in content from 10 parts by weight to 45 parts by weight, for example, 10 parts by weight, 15 parts by weight, 20 parts by weight, 25 parts by weight, 30 parts by weight, 35 parts by weight, 40 parts by weight, or 45 parts by weight. In some embodiments, when the photopolymerizable monomer comprises a compound with chemical formula (1) and a compound with chemical formula (2), and the weight ratio of the preferable compound with chemical formula (1) and the preferable compound with chemical formula (2) is from 1:1 to 12:1, for example, 1:1, 2:1, 3:1, 4:1, 5:1, 6:1, 7:1, 8:1, 9:1, 10:1, 11:1 or 12:1.

Next, the heat-expandable microcapsule is introduced. When the heat-expandable microcapsules are used in the continuous liquid interface production process with dual-cure resin mixtures, they are mixed in the matrix resin to form a foamable resin composition. During the printing process of the continuous liquid interface production, the foamable resin composition is light-cured to form an intermediate object, which contains the microcapsules. These heat-expandable microcapsules have not yet expanded. Next, the intermediate object is heated for further curing and at the same time, the heat-expandable microcapsules mixed within the intermediate object expand due to heat. During the heating process, while intermediate object undergoes thermal curing, the microcapsules continue to expand. As the heating continues, the volume of the heat-expandable microcapsule gradually expands and, meanwhile, the intermediate object is gradually cured by heat. The final product, composed of the urethane (meth) acrylate oligomer, has a larger volume than the volume of the original intermediate object output by the printing machine of continuous liquid interface production (CLIP). In some embodiments, the expansion speed of the heat-expandable microcapsule is about the same as the curing speed of the matrix resin. In some embodiments, the expansion speed of the heat-expandable microcapsule is faster than the curing speed of the matrix resin. In some embodiments, the expansion speed of the heat-expandable microcapsule is slower than the curing speed of the matrix resin.

More explanations of heat-expandable microcapsules are provided as follows. In some embodiments, the heat-expandable microcapsule comprises a polymer outer shell and volatile liquid enclosed within. When the temperature exceeds the glass transition temperature of the polymer outer shell of polymers, the polymer outer shell softens, and the internal pressure increases due to gasification of the volatile liquid, causing the polymer outer shell to expand outward. In some embodiments, the polymer outer shell includes long-chain carbon polymers that soften upon heating; for example, an outer shell made of nitrile-based compound, particularly a copolymer composed of acrylonitrile and methacrylonitrile. In some embodiments, the enclosed volatile liquid comprises low carbon alkanes, particularly liquid alkanes that convert to gas upon heating, such as isobutane, isopentane, isohexane, or other alkanes that are liquid at room temperature but volatilize into gas when heated. In some embodiments, since the shape and particle size of the heat-expandable microcapsule are generally uniform, the void formed in the final product after heating and expansion tends to have a consistent shape and volume. In some embodiments, the preferred shape of the heat-expandable microcapsules is spherical or ellipsoidal. In some embodiments, the preferred particle size of the heat-expandable microcapsule before expansion is from 5 μm to 100 μm, more preferably from 10 μm to 50 μm, most preferably 10 μm to 30 μm. In some embodiments, the heat-expandable microcapsules contained in the foamable resin composition are in content of 1-25 parts by weight, for example, 1 parts by weight, 5 parts by weight, 10 parts by weight, 15 parts by weight, 20 parts by weight, or 20 parts by weight. The outer shell of the heat-expandable microcapsule generally remains intact after expansion, providing partial structural support to the final product.

In some embodiments, the polymer outer shell of the heat-expandable microcapsule may contain coloring materials. In some embodiments, the coloring material from the heat-expandable microcapsule can diffuse into the matrix resin when dispensed and blended in the foamable resin composition, giving the final products a rich colored appearance. In some embodiments, heat-expandable microcapsules containing coloring materials can either be purchased from commercial suppliers or produced in house. The latter involves mixing the commercially sold pigments with colorless heat-expandable microcapsules to create colored version.

In some embodiments, the heat-expandable microcapsules can be microcapsules purchased from commercial suppliers or manufactured in-house through known production methods. Microcapsules available from commercial suppliers include, but are not limited to, the UNICELL product series by Dongjin Semichem, for example, UNICELL-DS series (such as, D300L, D600, D900, D1100, D1300, D2500), G series (for example, G, GP9, GP3, GP5), MS series (for example, MS140DS/D, MS2002, MS4002, MS4600, MS180DY, MS190D, MS197D), PG series (for example, PG-40, PG-42, PG-12, PG46, PG26, PG-18, PG-16); the Micropearl product series by Sekisui Chemical Co., Ltd., for example, Micropearl SP series (for example, SP-210, SP-2095, SP-209, SP-208, SP-207, SP-206, SP-205, SP-204, SP-203), Micropearl EX series (for example, EX-0055, EX-005, EX-00475, EX-0045), Micropearl EXH series (SP-0069, SP-0068, SP-0067, SP-0066, SP-0065, SP-0062, SP-006, SP-0058, SP-0055, SP-0049), Micropearl EZ series (for example, EZ3P-020, EZ4P-030), Micropear SLC series, Micropearl WS series (WS-606, WS-608, WS-302, WS-101); Matsumoto Microsphere® product series by Matsumoto Yushi-Seiyaku Co., Ltd., for example, F series (for example, F-30, F-36), FN series (for example, FN-65, FN-100S), HF series or MSH series (for example, MSH890, MSH550, MSH380, MSH340, F-AC160D, HF-36D); Expancel® product series by AkzoNobel, for example, WE series (for example, 921WE40), DE series (for example, 920DE40), WUF series (for example, 031WUF40, 007WUF40); products of H series and S series by Kureha Corporation.

Next, the photoinitiator is introduced. The photoinitiator facilitates the aforementioned crosslinking reactions to happen through light absorption. In some embodiments, the photoinitiator comprises diphenyl (2,4,6-trimethylbenzoyl) phosphine oxide (TPO).

Further explanations of the foamable resin composition are provided as follows. In some embodiments, the foamable resin composition disclosed in any of the aforementioned embodiments further comprises a hardener that provides the foamable resin composition with different curing mechanisms in order to create desired capabilities. In some embodiments, the hardener comprises 3,3′-dimethyl-4,4′-diaminodicyclohexylmethane (DMDC). In some embodiments, the hardener in the foamable resin composition is in content from 0 parts by weight to 70 parts by weight, for example, 0 parts by weight, 3 parts by weight, 5 parts by weight, 10 parts by weight, 30 parts by weight, 50 parts by weight, or 70 parts by weight.

Further explanations of the foamable resin composition are provided as follows. In some embodiments, the foamable resin composition disclosed in any of the aforementioned embodiments further comprises a coloring material that imparts the desired color to final products produced by 3D printing. In some embodiments, the coloring material comprises any applicable coloring materials, for example, white titanium dioxide or carbon black. In some embodiments, the coloring materials can be resin dyes (masterbatch), thermochromic materials, or photochromic materials (solar discoloration ink). In some embodiments, the coloring material in the foamable resin composition is in content from 0 parts by weight to 10 parts by weight, for example, 0 parts by weight, 0.01 parts by weight, 0.05 parts by weight, 0.1 parts by weight, 0.5 parts by weight, 1 part by weight, 3 parts by weight, or 10 parts by weight.

Further explanations of the foamable resin composition are provided as follows. In some embodiments, the foamable resin composition further comprises a filler that enhances final products with desired capabilities, for example, glass fiber, glass particles, hollow glass beads, metal powder, anti-UV agent, silicon-based antifouling powder, or fluorine-based antifouling powder.

Further explanations of the foamable resin composition are provided as follows. In some embodiments, the foamable resin composition disclosed in any of the aforementioned embodiments further comprises any applicable thermoplastic resins. In some embodiments, the types of thermoplastic resins are disclosed and cited in U.S. Pat. No. 9,453,142.

The present disclosure also provides a finished resin product which is manufactured from the aforementioned foamable resin composition by means of light exposure and heating. Light exposure (for example, ultraviolet) stimulates the photoinitiator to facilitate crosslinking reactions between the urethane (meth) acrylate oligomers and photopolymerizable monomers to produce cured intermediate objects. Heating (for example, to a temperature of 110° C.) causes the heat-expandable microcapsules to expand. As a result, the aforementioned cured intermediate object composed of urethane (meth) acrylate oligomer and photopolymerizable monomer also expand and form an enlarged finished product. In some embodiments, light exposure occurs before heating. During this exposure, reactions between the photopolymerizable monomer and the urethane (meth) acrylate oligomer are fully completed before the heating process begins. In some embodiments, the volume expansion ratio between the volume of the finished resin product compared to the volume of the resin product before expansion (that is, compared with the volume of the cured intermediate object) ranges from 110% to 305%. The volume expansion ratio is calculated by dividing the volume changes by the volume before expansion and then multiplied by 100. In some embodiments, the finished product includes a plurality of closed-cell structures; the shape and size of these closed cells are generally uniform, and the plurality of closed-cell structures are uniformly distributed throughout the finished product. The closed-cell structure contains air, which provides the finished resin product with insulating properties, such as electrical, thermal, and acoustic insulation. Moreover, the finished product also provides shock absorption, compressibility, and ductility. In summary, due to these aforementioned beneficial properties, the present disclosure can be implemented in various applications. For example, the foamable resin composition of the present disclosure can be used in the 3D printing of shoe soles.

The foamable resin composition of the present disclosure and finished resin products thereof are introduced based on several embodiments as follows. However, these detailed descriptions in practice are for illustration only and shall not be interpreted to limit the scope, applicability, or configuration of the present disclosure in any way.

The experiments were conducted to compare the volume expansion ratio in finished resin products by crosslinking the photopolymerizable monomer and the urethane (meth) acrylate oligomer, using different types of photopolymerizable monomer as variables (that is, all controllable variables in experimental example 1 through experimental example 4 are identical except for the types of photopolymerizable monomers used). The compositions and concentrations of the foamable resin compositions for each experimental example are listed in Table 1; the experimental outcomes are recorded in Table 2, wherein the urethane (meth) acrylate oligomer is, for example, a compound with the chemical formula (7). The heat-expandable microcapsule comprises, for example, an outer shell made of a copolymer composed of acrylonitrile and methacrylonitrile, with isopentane encapsulated within.

TABLE 1
Composition and concentration (concentration unit is parts by weight)

| | urethane (meth) | | | heat- | | | | PEG |
|---|---|---|---|---|---|---|---|---|
| | acrylate | | | expandable | | | | (200) |
| | oligomer | TPO | DMDC | microcapsule | MMA | LMA | IBOA | DMA |
| Experimental | 70 | 1 | 5 | 5 | 20 | 0 | 0 | 0 |
| example 1 | | | | | | | | |
| Experimental | 70 | 1 | 5 | 5 | 0 | 20 | 0 | 0 |
| example 2 | | | | | | | | |
| Experimental | 70 | 1 | 5 | 5 | 0 | 0 | 20 | 0 |
| example 3 | | | | | | | | |
| Experimental | 70 | 1 | 5 | 5 | 0 | 0 | 0 | 20 |
| example 4 | | | | | | | | |

TABLE 2
Experimental outcomes

| | volume expansion |
|---|---|
| | ratio (%) |
| Experimental example 1 | 245.55 |
| Experimental example 2 | 183.71 |
| Experimental example 3 | 245.55 |
| Experimental example 4 | 123.32 |

Experiment 2 was conducted to compare the effects of different combinations of photopolymerizable monomers and the concentration ratio of various groups within the foamable resin composition on the volume expansion ratio of finished resin products. In experiment 2, the compositions and concentrations of the foamable resin composition for experimental example 5 and experimental example 6 are listed in Table 3; the experimental outcomes are documented in Table 4, wherein the urethane (meth) acrylate oligomer is, for example, a compound with the chemical formula (7); the coloring material used is, for example, the aforementioned white titanium dioxide; the heat-expandable microcapsule, for example, consists of an outer shell made of a copolymer of acrylonitrile and methacrylonitrile, with isopentane encapsulated within.

TABLE 3
Composition and concentration (concentration unit is parts by weight)

| | urethane (meth) | | PEG | | | | | heat- |
|---|---|---|---|---|---|---|---|---|
| | acrylate | | (600) | | | | coloring | expandable |
| | oligomer | LMA | DMA | IBOA | DMDC | TPO | material | microcapsule |
| Experimental | 70 | 20 | 2 | 2 | 5 | 1 | 0.3 | 10 |
| example 5 | | | | | | | | |
| Experimental | 70 | 15 | 15 | 0 | 5 | 1 | 0.3 | 10 |
| example 6 | | | | | | | | |

TABLE 4
Experimental outcomes

| | volume expansion |
|---|---|
| | ratio (%) |
| Experimental example 5 | 303.45 |
| Experimental example 6 | 178.70 |

The viscosity of the foamable resin composition of the present disclosure is moderate to prevent reduction in the quality of 3D printing during the use of the foamable resin composition. In addition, the foamable resin composition undergoes a superior foaming process, which enhance both production capacity and efficiency of 3D printing.

The present disclosure is described in detail using several embodiments that are feasible. Therefore, the above-preferred embodiments are presented to disclose the present disclosure and shall not be interpreted to limit the scope, applicability, or configuration of the present disclosure in any way.

Those skilled in the art may use any alternative embodiments that are modified or changed without departing from the spirit and scope of the present disclosure and shall be included in the appended claims.

What is claimed is:

1. A foamable resin composition, comprising:
a urethane (meth) acrylate oligomer having an inclusion quantity from 20 to 90 parts by weight;
a photoinitiator having an inclusion quantity from 0.1 to 10 parts by weight;
a heat-expandable microcapsule having an inclusion quantity from 1 to 25 parts by weight; and
a photopolymerizable monomer having an inclusion quantity from 10 to 45 parts by weight, wherein:
the photopolymerizable monomer comprises at least one compound with chemical formula R—Xa, having a group of a reactive functional group X and a non-reactive functional group R,
the non-reactive functional group R is selected from a group consisting of a small molecule group, a group with steric hindrance, a group with side reaction sites, and a long chain group,
a weight ratio of the urethane (meth) acrylate oligomer and the photopolymerizable monomer in the foamable resin composition is from 1.5:1 to 2.5:1, and
the photopolymerizable monomer comprises:
a compound with chemical formula (1), 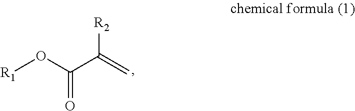
wherein R₁ is a straight-chain or branched-chain alkyl of C1-C18, a substituted cycloalkyl or non-substituted cycloalkyl, or a substituted aryl or non-substituted aryl, and R₂ is hydrogen or methyl,
at least one of a compound with chemical formula (2) or (3) 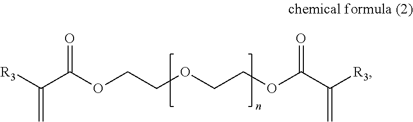
wherein R₃ is hydrogen or methyl and n is any integer from 3 to 12, 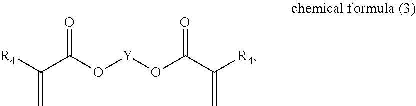
wherein Y is a straight-chain or branched-chain alkylene of C1-C18, or a substituted or non-substituted cycloalkylene, and R₄ is hydrogen or methyl, and
at least one of a compound with chemical formula (4) or (5), 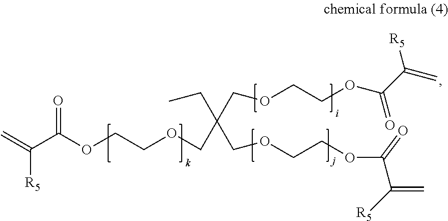
wherein i+j+k=15, and R₅ is hydrogen or methyl; 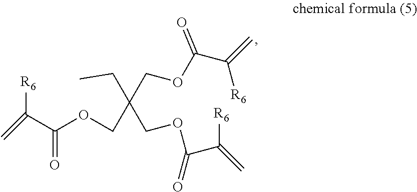
wherein R₆ is hydrogen or methyl.

2. The foamable resin composition of claim 1, wherein the heat-expandable microcapsule comprises an outer shell made of nitrile-based polymers enclosing an alkane-based compound, wherein the alkane-based compound comprises low carbon alkanes in the form of volatile liquids.

3. The foamable resin composition of claim 1, wherein the foamable resin composition optionally comprises a hardener having an inclusion quantity of 0-70 parts by weight.

4. The foamable resin composition of claim 1, wherein R₁ is methyl, ethyl, tert-butyl, dodecyl, octadecyl, isodecyl, isooctyl, isononyl, cyclohexyl, isobornyl, 2-methyl-2-adamantyl, phenyl, benzyl, phenoxy or phenol.

5. The foamable resin composition of claim 1, wherein the compound with the chemical formula (2) comprises polyethylene glycol (200) diacrylate, polyethylene glycol (400) diacrylate, polyethylene glycol (600) diacrylate, polyethylene glycol (200) dimethacrylate, polyethylene glycol (400) dimethacrylate, polyethylene glycol (600) dimethacrylate, or a combination thereof, and the compound with the chemical formula (3) comprises tricyclodecane dimethanol diacrylate, 1,4-butanediol dimethacrylate, or a combination thereof.

6. The foamable resin composition of claim 1, wherein a viscosity of the foamable resin composition is from 100 cps to 10,000 cps at 25° C.

7. The foamable resin composition of claim 2, wherein a particle size of the heat-expandable microcapsule is from 5 μm to 100 μm.

8. The foamable resin composition of claim 1, wherein the inclusion quantity of the photopolymerizable monomer with chemical formula R—Xa and a≥2 in the foamable resin composition is from 0.1 parts by weight to 20 parts by weight.

9. The foamable resin composition of claim 1, wherein at least one photopolymerizable monomer compound has a viscosity of 50 cps or more that accounts for less than 45 parts by weight in the foamable resin composition, and at least one photopolymerizable monomer compound has a viscosity of 100 cps or more that accounts for less than 20 parts by weight in the foamable resin composition.
